(19) United States
(12) Patent Application Publication
(10) Pub. No.: US 2025/0103486 A1
(43) Pub. Date: Mar. 27, 2025

(54) STORAGE DEVICE INCLUDING MEMORY CONTROLLER AND OPERATING METHOD OF MEMORY CONTROLLER

(71) Applicant: Samsung Electronics Co., Ltd., Suwon-si (KR)

(72) Inventors: Chanha KIM, Suwon-si (KR); Jiyeun KANG, Suwon-si (KR); Alain TRAN, Suwon-si (KR); Soojun IM, Suwon-si (KR)

(73) Assignee: Samsung Electronics Co., Ltd., Suwon-si (KR)

(21) Appl. No.: 18/770,795

(22) Filed: Jul. 12, 2024

(30) Foreign Application Priority Data
Sep. 25, 2023 (KR) 10-2023-0128484

(51) Int. Cl. G06F 12/02

(52) U.S. Cl. CPC G06F 12/0246; G06F 2212/7205

(57) ABSTRACT

A storage device includes a non-volatile memory device including a plurality of memory blocks; and a memory controller configured to control a garbage collection operation of copying valid data of a source block among the plurality of memory blocks to a destination block. The memory controller is configured to read a logical address stored in a page included in the source block, determine a validity of user data stored in the page included in the source block based on the logical address, read the valid data, which includes the user data determined to be valid, from the non-volatile memory device, and perform a write operation on the destination block by transferring the read valid data to the non-volatile memory device.

### CROSS-REFERENCE TO RELATED APPLICATION

This application is based on and claims ranking under 35 U.S.C. § 119 to Korean Patent Application No. 10-2023-0128484, filed on Sep. 25, 2023 in the Korean Intellectual Property office, the contents of which are incorporated by reference herein in their entirety.

### BACKGROUND

Various non-limiting example embodiments relate, in general, to a storage device, and more particularly, to a storage device for reducing garbage collection time by determining the validity of user data stored in a source block based on a logical address, reading valid data, and writing the valid data to a destination block.

Storage devices, such as a solid state drive (SSD), non-volatile memory expression (NVMe), an embedded multi-media card (eMMC), and a universal flash storage (UFS), using non-volatile memory devices are widely used.

As data is continuously written to a flash memory, valid data may be scattered throughout the flash memory, and accordingly, to secure a free memory block, which corresponds to a data-writeable storage space, it is necessary or desirable to perform garbage collection for moving valid data of at least one memory block to another memory block and performing an erase operation on the memory block.

When a valid page bitmap (VPB) is used, which indicates that valid data is not stored in the storage device to reduce the memory usage of the storage device, the valid data is determined only after reading all the data of the page, and accordingly, the time required to perform the garbage collection operation may be lengthened.

Thus, there is a need or a desire for technology for rapidly performing the garbage collection operation.

### SUMMARY

Various example embodiments provide a storage device capable of improving the efficiency of a garbage collection operation by reading only the valid data from a non-volatile memory device after valid data stored in a page is identified based on a logical address, and/or an operating method of a memory controller.

According to various example embodiments, there is provided a storage device including a non-volatile memory device including a plurality of memory blocks; and a memory controller configured to control a garbage collection operation of copying valid data of a source block among the plurality of memory blocks to a destination block. The memory controller is configured to read a logical address stored in a page included in the source block, determine a validity of user data stored in the page included in the source block based on the logical address, read the valid data, which includes the user data determined to be valid, from the non-volatile memory device, and perform a write operation on the destination block by transferring the read valid data to the non-volatile memory device.

Alternatively or additionally according to various example embodiments, there is provided a storage device including a non-volatile memory device including a plurality of memory blocks; and a memory controller configured to control a garbage collection operation of copying valid data of a source block among the plurality of memory blocks to a destination block. The memory controller is configured to determine whether a detection condition for performing a garbage collection operation on the source block is satisfied, in response to the detection condition being satisfied, perform the garbage collection operation according to a first process, in which a logical address stored in a page included in the source block is read, and in response to the detection condition not being satisfied, perform the garbage collection operation according to a second process, in which the logical address and user data stored in the page included in the source block are read.

Alternatively or additionally according to various example embodiments, there is provided an operating method including selecting a source block and a destination block among a plurality of memory blocks included in a non-volatile memory device; and performing the garbage collection operation on the source block and the destination block. The performing of the garbage collection operation comprises, reading a logical address stored in a page included in the source block, determining validity of user data stored in the page based on the logical address, reading, from the non-volatile memory device, valid data determined to be valid among the user data, and writing the valid data to the destination block.

### BRIEF DESCRIPTION OF THE DRAWINGS

Various example embodiments will be more clearly understood from the following detailed description taken in conjunction with the accompanying drawings in which:

FIG. 1 is a block diagram of a storage device according to some example embodiments;

FIG. 2 is a block diagram for describing a host-storage system including a host and a storage device, according to some example embodiments;

FIG. 3 illustrates a block diagram of a non-volatile memory device according to some example embodiments;

FIG. 4 is a diagram describing a memory cell array according to some example embodiments;

FIG. 5 is a diagram of a mapping table according to some example embodiments;

FIG. 6 is a diagram for describing a garbage collection operation according to a first process, according to some example embodiments;

FIG. 7A illustrates a case in which three pieces of user data stored in a page are valid data;

FIG. 7B illustrates a case in which two pieces of user data stored in a page are valid data;

FIG. 7C illustrates a case in which one piece of user data stored in a page is valid data;

FIG. 8 is a flowchart for explaining an operation method of a memory device, according to some example embodiments;

FIG. 9 is a flowchart illustrating an operating method of a memory controller depending on whether a detection condition is satisfied, according to some example embodiments;

FIG. 10 is a diagram for describing a garbage collection operation according to a second process, according to some example embodiments;

FIG. 11 is a diagram for describing a case in which a detection condition is satisfied, according to some example embodiments;

FIG. 12 is a diagram for describing a case in which a detection condition is not satisfied, according to some example embodiments;

FIG. 13 is a diagram for describing a case in which a detection condition is satisfied at a first time point, according to some example embodiments;

FIG. 14 is a diagram for describing a case in which a detection condition is not satisfied at a first time point, according to some example embodiments;

FIG. 15 is a diagram for describing a case of determining whether a detection condition is satisfied at a plurality of time points, according to some example embodiments;

FIG. 16 is a diagram for describing a case of determining whether a detection condition is satisfied at each time when a page is read, according to some example embodiments; and

FIG. 17 is a system to which storage devices are applied according to some example embodiments.

### DETAILED DESCRIPTION OF VARIOUS EXAMPLE EMBODIMENTS

Hereinafter, some example embodiments are described in detail with reference to the accompanying drawings. Identical reference numerals are used for the same constituent elements in the drawings, and duplicate descriptions thereof are omitted.

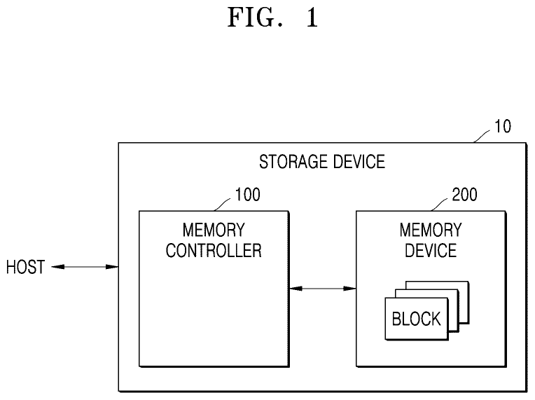

FIG. 1 is a block diagram illustrating a storage device according to some example embodiments.

Referring to FIG. 1, the storage device 10 may communicate with a host. The storage device 10 may communicate with the host via various interfaces. For example, the storage device 10 may communicate with the host via various interfaces, such as one or more of a universal serial bus (USB), multi-media card (MMC), embedded MMC, peripheral component interconnection (PCI), PCI-express (PCI-E), advanced technology attachment (ATA), serial-ATA, parallel-ATA, small computer system interface (SCSI), enhanced small disk interface (ESDI), integrated drive electronics (IDE), Firewire, universal flash storage (UFS), and non-volatile memory (NVM) express (NVMe).

According to some example embodiments, the storage device 10 may include a non-volatile memory device such as flash memory. In some example embodiments, the storage device 10 may be implemented by being embedded in an electronic device or be implemented as a removable memory, and for example, the storage device 10 may be implemented in various forms of, for example, one or more of an embedded universal flash storage (UFS) memory device, an eMMC, a solid state drive (SSD), a UFS memory card, a compact flash (CF) card, a secure digital (SD) card, a micro-SD card, a mini-SD card, an extreme digital (xD) card, or a memory stick.

The storage device 10 may include a memory controller 100 and a memory device 200. The memory device 200 may include, e.g., may be partitioned into, a plurality of blocks.

The memory controller 100 may control the overall operation of the storage device 10. The memory controller 100 may also be referred to as a controller, a device controller, or a storage controller.

When power is applied from the outside to the storage device 10, the memory controller 100 may execute firmware. When the memory device 200 includes a flash memory device, firmware may include one or more of a host interface layer (HIL), a flash translation layer (FTL), and a flash interface layer (FIL).

The memory controller 100 may control the memory device 200 to perform a program operation (or a write operation) in response to a write request of the host. During the program operation, the memory controller 100 may provide a program command (or a write command), a physical address, and data to the memory device 200.

Alternatively or additionally, the memory controller 100 may control the memory device 200 to perform a read operation in response to a read request of the host. During the read operation, the memory controller 100 may provide a read command and a physical address to the memory device 200.

Alternatively or additionally, the memory controller 100 may control the memory device 200 to perform an erase operation in response to an erase request of the host. During the erase operation, the memory controller 100 may provide an erase command and a physical address to the memory device 200.

The memory controller 100 may transmit one or more of its own generated command, address, and data to the memory device 200 regardless of the request provided by the host. For example, the memory controller 100 may generate a command, an address, and data for performing a background operation, and provide the command, address, and data to the memory device 200. The background operation may include, for example, one or more of wear leveling, read reclaim, or garbage collection.

The memory controller 100 may control a garbage collection operation of the memory device 200 on the memory blocks. The memory controller 100 may select a source block from a plurality of blocks of the memory device 200, and after copying valid data of the source block to a destination block, by performing the garbage collection operation of erasing the source block, the memory controller 100 may secure usable capacity in the memory device 200.

In some example embodiments, during the garbage collection operation, the memory controller 100 may read a logical address stored in a page included in the source block of the memory device 200. For example, the memory controller 100 may load a logical address and user data from a page included in the source block to a data buffer included in the memory device 200, and then may read the logical address from the data buffer. Reading the logical address from the data buffer may also be referred to as reading the logical address from the source block, or reading the logical address from the memory device 200. Alternatively or additionally, reading data from the data buffer may also be referred to as reading data from one of the source block, the memory device 200, and the page.

The source block may include a plurality of pages, and each of the plurality of pages may include user data and the logical address. The memory controller 100 may not read all of the user data and the logical address, but may read the logical address first.

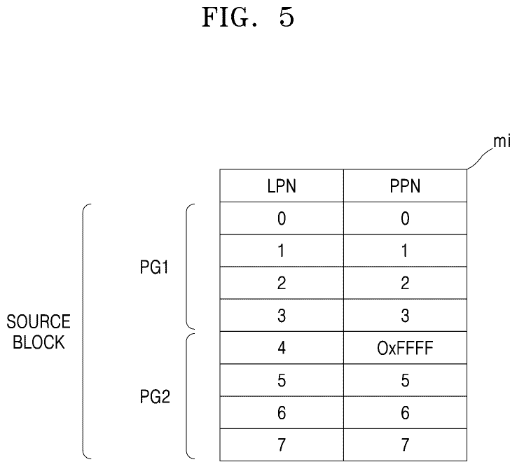

In some example embodiments, the memory controller 100 may determine the validity of the user data. The memory controller 100 may determine the validity of the user data based on the read logical address. The user data determined to be valid from among the user data stored in the page may include valid data. The memory controller 100 may, before reading the user data from the source block, identify which user data is the valid data by using the read logical address and a mapping table. The mapping table may include information representing a mapping relationship (e.g., a one-to-one, a many-to-one, a one-to-many, or a many-to-many relationship) between the logical address and the physical address. A method of determining validity of the user data by the memory controller 100 is described below with respect to FIG. 5.

The memory controller 100 may identify the valid data, and read the valid data from the source block of the memory device 200. The memory controller 100 may write the read valid data to the destination block.

In some example embodiments, the memory controller 100 may control the garbage collection operation method according to whether a detection condition for performing the garbage collection operation on the source block is satisfied. When the detection condition is satisfied, the memory controller 100 may perform the garbage collection operation according to the first process. As described above, the first process may mean or may correspond to a garbage collection operation in which a reading operation of a logical address from a source block, an identifying operation of valid data from user data based on the logical address, and a reading operation of valid data from the memory device 200 and writing the read valid data to the destination block are sequentially performed. In some example embodiments, the first process may not include a reading operation of the user data concurrently with the reading operation of the logical address from the source block.

When the detection condition is not satisfied, the memory controller 100 may perform the garbage collection operation according to the second process. The second process may mean or correspond to a garbage collection operation in which a reading operation of the logical address and the user data from the page of the source block, an identifying operation of valid data among the read user data by using the logical address, and a write operation of the identified valid data to the destination block are sequentially performed.

In some example embodiments, the memory device 200 may include a non-volatile memory device. For example, the non-volatile memory device may include a NAND flash memory device. When the memory device 200 includes a flash memory, the flash memory may include a two-dimensional (2D) NAND array and/or a three-dimensional (3D) (or vertical) NAND memory array. However, example embodiments are not limited thereto, and the memory device 200 may alternatively or additionally include a resistive memory device, such as one or more of a resistive random access memory (RAM) (ReRAM), phase change RAM (PRAM), and magnetic RAM (MRAM). Hereinafter, descriptions are given with an assumption that the memory device 200 includes a NAND flash memory.

The memory device 200 may include, e.g., may be partitioned into, a plurality of memory blocks (the memory blocks may also be referred to as a block). Each of the plurality of memory blocks may include or be partitioned into a plurality of pages, and each of the plurality of pages may include a plurality of memory cells sharing one word line. For example, a block may be a unit of erase, and a page may be a unit of write (a program) and read.

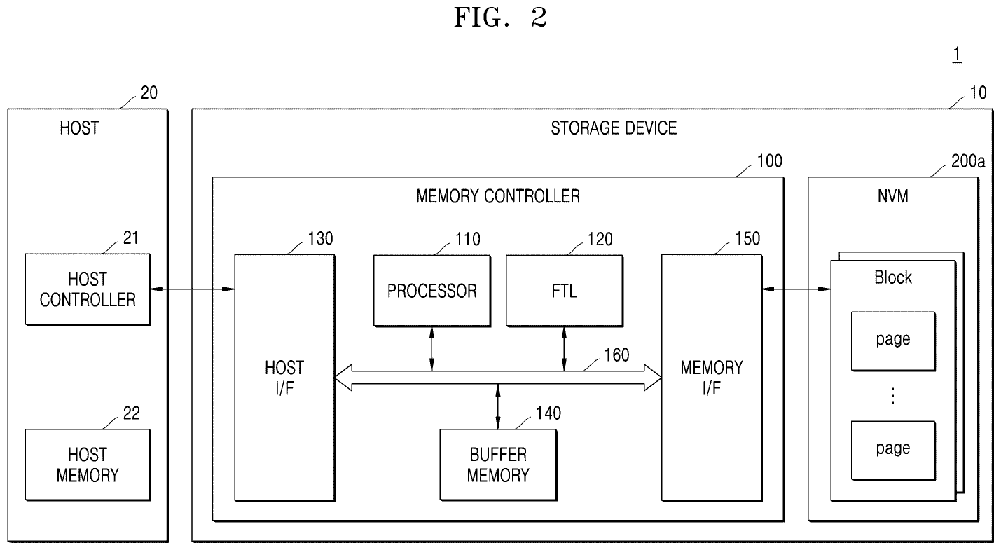

FIG. 2 is a block diagram for describing a host-storage system 1 including a host and a storage device, according to some example embodiments. The storage device 10, the memory controller 100, and a non-volatile memory device (NVM) 200a in FIG. 2 may respectively correspond to the storage device 10, the memory controller 100, and the memory device 200 in FIG. 1, and thus, duplicate descriptions thereof are omitted.

Referring to FIG. 2, the host-storage system I may include the storage device 10 and the host 20, and the storage device 10 may include the memory controller 100 and the NVM 200a. In addition, according to some example embodiments the host 20 may include a host controller 21 and a host memory 22. The host memory 22 may function as a buffer memory for temporarily storing data to be transmitted to the storage device 10 or data transmitted by the storage device 10.

According to some example embodiments, the host controller 21 and the host memory 22 may be implemented as separate semiconductor chips. Alternatively, according to some embodiments, the host controller 21 and the host memory 22 may be integrated into the same semiconductor chip. For example, the host controller 21 may include one or more of various modules provided in an application processor, and the application processor may be implemented as a system on chip (SoC). In addition, the host memory 22 may include an embedded memory provided in the application processor, and/or an NVM or a memory module arranged outside the application processor.

The memory controller 100 may include a processor 110, an FTL 120, a host interface 130, a buffer memory 140, and a memory interface (I/F) 150, and these components may communicate with each other via a bus 160. The bus 160 may be or may include a wired bus and/or a wireless bus; example embodiments are not limited thereto. The processor 110 may include a central processing unit (CPU), a microprocessor, or the like, and may control the overall operation of the memory controller 100. In some example embodiments, the processor 110 may be implemented as a multi core processor, for example, a dual core processor or a quad core processor. The buffer memory 140 may temporarily store data to be stored in the NVM 200a or data to be read from the NVM 200a. The buffer memory 140 may be a component arranged in the memory controller 100 but may be arranged outside the memory controller 100. For example, the memory controller 100 may further include a buffer memory manager or a buffer memory interface for communicating with the buffer memory 140.

The memory controller 100 may further include a working memory (not illustrated), upon which the FTL 120 is loaded, and the write operation and the read operation on the NVM 200a may be controlled by the processor 110 executing the FTL 120. The garbage collection operation on the NVM 200a may be controlled by the processor 110 executing the FTL 120. For example, the working memory may be implemented as or may include one or more of a volatile memory, such as one or more of static RAM (SRAM) and dynamic RAM (DRAM), or an NVM, such as flash memory and/or PRAM.

In addition, the FTL 120 may perform various functions, such as address mapping and wear-leveling. An address mapping operation may include an operation of changing a logical address read from the host 20 to a physical address used for actually storing data in the NVM 200a. The wear-leveling operation may include a technique for preventing excessive deterioration of a particular block by uniformly using blocks BLK in the NVM 200a.

The host I/F 130 may transceiver (or, transmit and receive) packets to and from the host 20. A packet transmitted from the host 20 to the host I/F 130 may include a command, data to be recorded in the NVM 200a, or the like, and a packet transmitted from the host interface 130 to the host 20 may include a response to the command, data read from the NVM 200a, etc. The memory I/F 150 may transmit data to be recorded in the NVM 200a to the NVM 200a or receive data read from the NVM 200a. The memory I/F 150 may be implemented to comply with standard conventions, such as a toggle and/or an open NAND flash interface (ONFI).

In some example embodiments, although not illustrated in FIG. 2, the memory controller 100 may further include one or more of a packet manager, an error correction code (ECC) engine, and an advanced encryption standard (AES) engine. The packet manager may generate a packet according to an interface protocol complying with the host 20 or may parse various pieces of information from the packet received from the host 20.

The ECC engine may perform error detection and correction function of the read data read from the NVM 200a. The ECC engine may generate parity bits for write data to be stored in the NVM 200a, and the generated parity bits may be stored in the NVM 200a together with the write data. When reading data from the NVM 200a, the ECC engine may correct errors in the read data by using parity bits read from the NVM 200a together with the read data, and output corrected read data with corrected errors.

The AES engine may perform at least one of an encryption operation and a decryption operation for data input to the memory controller 100 by using a symmetric-key algorithm.

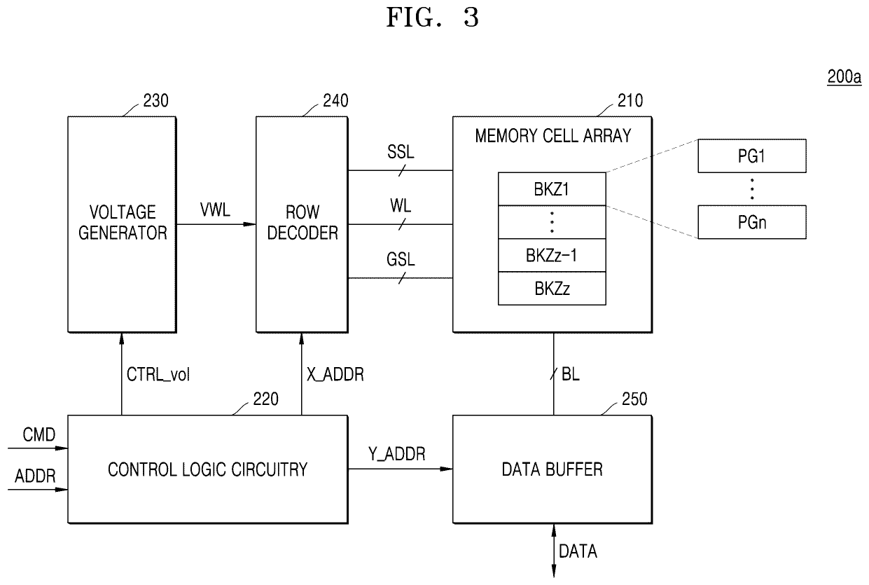

FIG. 3 illustrates a block diagram of the NVM 200a according to some example embodiments. Referring to FIG. 3, the NVM 200a may include a memory cell array 210, control logic circuitry 220, a voltage generator 230, a row decoder 240, and a data buffer 250. The NVM 200a may correspond to an implementation of the memory device 200 in FIG. 1.

The memory cell array 210 may include first through z^{th} memory blocks BLK1 through BLKz, and each of the first through z^{th} memory blocks BLK1 through BLKz may include first through n^{th} pages PG1 through PGn, where z and n may be positive integers. The memory cell array 210 may be connected to the data buffer 250 via bit lines BL, and may be connected to the row decoder 240 via word lines WL, string selection lines SSL, and ground selection lines GSL.

In some example embodiments, the memory cell array 210 may include a 3D memory cell array, and the 3D memory cell array may include a plurality of NAND strings. Each NAND string may include memory cells respectively connected to the word lines WL vertically stacked on a substrate.

The control logic circuitry 220 may control all various operations in the NVM 200a. The control logic circuitry 220 may output various control signals in response to a command CMD and/or an address ADDR. For example, the control logic circuitry 220 may output a voltage control signal CTRL_vol, a row address X_ADDR, and a column address Y_ADDR to the voltage generator 230, the row decoder 240, the data buffer 250, respectively.

The voltage generator 230 may generate various types of voltages for performing program, read, and erase operations based on the voltage control signal CTRL_vol. For example, the voltage generator 230 may, as a word line voltage VWL, generate a program voltage, a read voltage, a program verification voltage, an erase voltage, etc.

The control logic circuitry 220 may perform the garbage collection operation on the source block among the first through z^{th} memory blocks BLK1 through BLKz. The control logic circuitry 220 may perform the garbage collection operation of copying the valid data of a page included in the source block to the destination block and erasing the source block under control by a memory controller.

The control logic circuitry 220 may perform the garbage collection operation according to the first process under control by the memory controller. In some example embodiments, the control logic circuitry 220 may perform the garbage collection operation differently depending on whether the detection condition is satisfied. When the detection condition is satisfied, the control logic circuitry 220 may perform the garbage collection operation according to the first process. When the detection condition is not satisfied, the control logic circuitry 220 may perform the garbage collection operation according to the second process.

The row decoder 240 may select one of the plurality of word lines WL in response to the row address X_ADDR, and may select one of the plurality of string selection lines SSL. For example, during the program operation, the row decoder 240 may apply the program voltage and the program verification voltage to the selected word line WL, and during the read operation, may apply the read voltage to the selected word line WL.

The data buffer 250 may select at least one bit line BL from among the bit lines BL in response to the column address Y_ADDR. The data buffer 250 may output data sensed by the memory cell array 210. The data buffer 250 may include a buffer, a latch, or the like for temporarily storing data sensed by the memory cell array 210. As an example, when the garbage collection operation is performed, the memory device 200a may transfer the logical address and the user data from the source block among the first through z^{th} memory blocks BLK1 through BLKz to the data buffer 250.

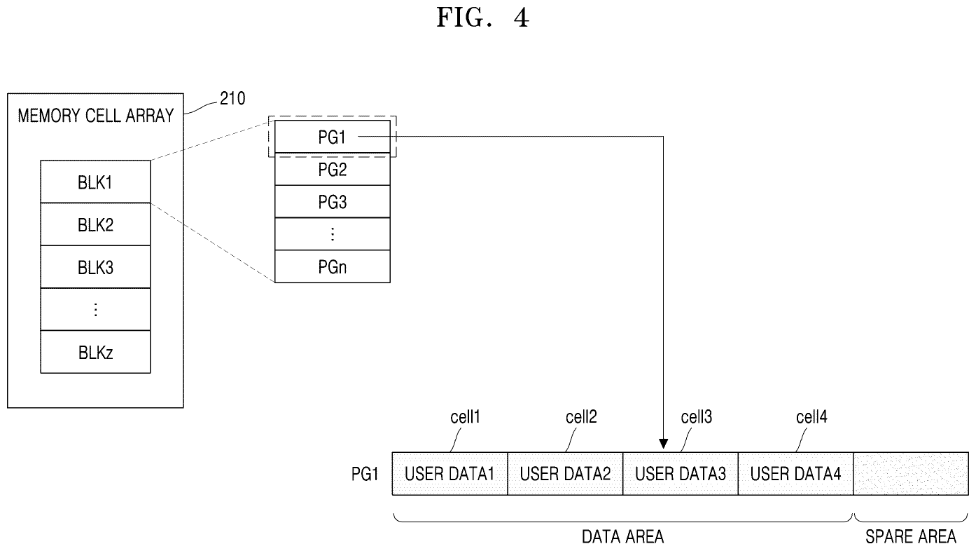

FIG. 4 is a diagram for describing a memory cell array 210 according to some example embodiments. The memory cell array 210 in FIG. 4 may correspond to the memory cell array 210 in FIG. 3, and thus, duplicate descriptions thereof are omitted.

Referring to FIG. 4, the memory cell array 110 may include the first through z^{th} memory blocks BLK1 through BLKz. Each of the first through first through z^{th} memory blocks BLK1 through BLKz may include the first through n^{th} pages PG1 through PGn. Each of the first through n^{th} pages PG1 through PGn may include a data area and a spare area. The data area may include the user data, and the spare area may include metadata. The metadata may include data for managing the user data or the like and may include the logical address.

In some embodiments, each of the first through n^{th} pages PG1 through PGn may include a plurality of cell areas. Each of the plurality of cell areas may store the user data. For example, each of the first through n^{th} pages PG1 through PGn may include four cell areas. As an example, the cell area may include a cell group including at least one cell. However, the number of cell areas include in one page is not necessarily limited thereto, and various number of cell areas may also be included in one page. Each of a first cell area cell1, a second cell area cell2, a third cell area cell3, and a fourth cell area cell4 may store the user data. As an example, each of the plurality of cell areas may store about 4 KB of the user data. However, some example embodiments is not limited thereto.

Each of the first through n^{th} pages PG1 through PGn may store the logical address corresponding to the user data stored in each page. As an example, the first page PG1 may store the logical address corresponding to the user data stored in the first page PG1. The first page PG1 may store the logical address corresponding to the user data stored in each of the first through fourth cell areas cell1 through cell4. The logical address may be mapped to the physical address indicating a physical location of each of the plurality of cell areas. In some example embodiments, a memory controller (for example, the memory controller 100 in FIG. 1) may read the logical address of the source block, and by using the logical address, may determine validity of the user data corresponding to the logical address.

Descriptions are given with an assumption of a case in which the first block BLK1 is the source block. In the first page PG1 of the first block BLK1, first user data, second user data, third user data, and fourth user data may be stored. When the storage device 10 performs the garbage collection operation, the valid data of the source block may be copied to the destination block. It may be necessary that only the valid data among first through fourth user data is copied to the destination block. Thus, the valid data among the user data may need to be identified. Hereinafter, a method in which a memory controller determines the valid data is described with reference to FIG. 5.

FIG. 5 is a diagram of a mapping table according to some example embodiments.

Referring to FIG. 5, mapping information mi may have a form of a mapping table. The mapping information may also be referred to as the mapping table. According to some example embodiments, a buffer memory (for example, the buffer memory 140 in FIG. 2) of a memory controller (for example, the memory controller 100 in FIG. 2) may load the mapping table. The mapping information may mean mapping information between a logical address LPN and a physical address PPN. The logical address LPN and the mapped physical address PPN may represent a location where the user data is stored. For example, the physical address PPN may represent a page, a cell area, or the like, which is stored in the user data.

On the other hand, the logical address LPN provided by the host 20 may be referred to as a logical page address (LPA), a logical page number LPN, or the like, and the physical address PPN may be referred to as a physical page address (PPA), the physical page number PPN, etc. Hereinafter, for convenience of description, the terms logical address LPN and physical address PPN may be used as the mapping information.

In some example embodiments, a memory controller (for example, the memory controller 100 in FIG. 1) may determine validity of the user data stored in the page of the source block by using the mapping information. The memory controller may read a logical address from a page of a source block, and may determine validity of user data corresponding to the logical address by using the logical address and mapping information.

The memory controller may identify a physical address corresponding to a logical address that is read by using mapping information. The memory controller may identify validity of a physical address corresponding to a logical address that is read by using mapping information. The shape of a physical address for a case in which user data is valid data may be different from the shape of a physical address for a case in which user data is not valid data,. For example, when user data is valid data, the physical address may be PPN1, and when the user data is not the valid data, the physical address may be 0xFFFF.

The memory controller may determine user data corresponding to a valid physical address to be valid data. For example, in the source block, the first page PG1 and a second page PG2 may be included. A case is assumed in which a first logical address LPN0 and a first physical address PPN0 correspond to the first user data of the first page PG1, a second logical address LPN1 and a second physical address PPN1 correspond to the second user data of the first page PG1, a third logical address LPN2 and a third physical address PPN2 correspond to the third user data of the first page PG1, and a fourth logical address LPN3 and a fourth physical address PPN3 correspond to the fourth user data of the first page PG1. The memory controller may determine the first through fourth user data stored in the first page PG1 to be the valid data.

A case is assumed in which a fifth logical address LPN4 corresponds to fifth user data of the second page PG2, a sixth logical address LPN5 and a sixth physical address PPN5 correspond to sixth user data of the second page PG2, a seventh logical address LPN6 and a seventh physical address PPN6 correspond to seventh user data of the second page PG2, and an eighth logical address LPN7 and an eighth physical address PPN7 correspond to eighth user data of the second page PG2. The memory controller may identify that the physical address corresponding to the fifth logical address LPN4 is 0xFFFF, and may determine the fifth user data stored in the second page PG2 to be invalid data, that is, not-valid data. The memory controller may determine the sixth through eighth user data stored in the second page PG2 to be the valid data.

In some example embodiments, the memory controller may read valid data among user data stored in a page. For example, the memory controller may read the first through fourth user data from the first page PG1. For example, the memory controller may not read the fifth user data from the second page PG2, but may read the sixth through eighth user data.

Because the memory controller determines the valid data by using the logical address even when valid information indicating validity of the user data (for example, a valid page bitmap (VPB)) is not stored in a storage device, the amount of memory may be reduced. In addition, the memory controller may determine valid data by reading only a logical address from a source block, and by reading the determined valid data, may not read all of the user data from the source block, and accordingly, the speed of the garbage collection operation may be increased.

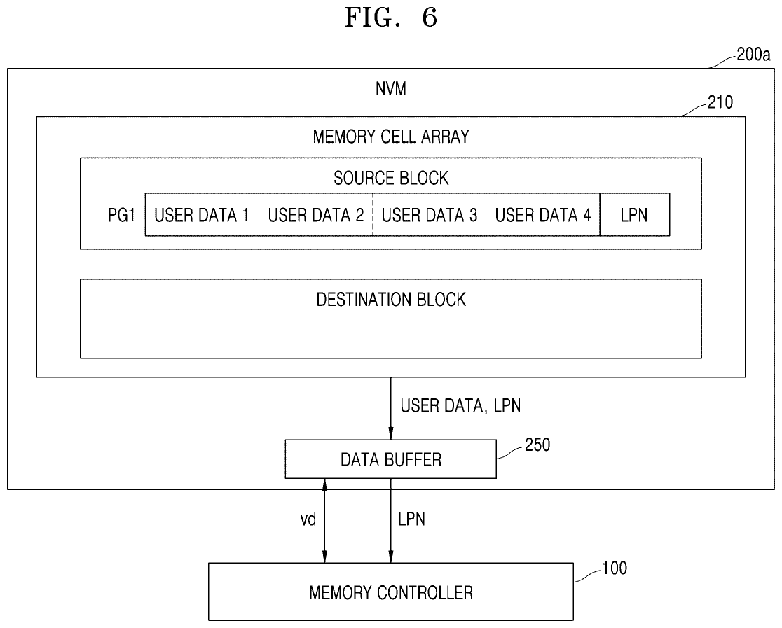

FIG. 6 is a diagram for describing a garbage collection operation according to the first process, according to some example embodiments. Duplicate descriptions in the descriptions given above are omitted.

Referring to FIG. 6, the memory cell array 210 may include a plurality of memory blocks, but for convenience of drawing, the source block and the destination block are illustrated. In addition, for convenience of description, the source block is illustrated as including the first page PG1, but is not necessarily limited thereto, and the source block may include various number of pages. The first page PG1 may include the user data and the logical address LPN. The first page PG1 is assumed to store the first user data, the second user data, the third user data, and the fourth user data. For example, each of the first user data, the second user data, the third user data, and the fourth user data may be about 4 KB, but is not necessarily limited thereto.

The memory controller 100 may perform the garbage collection operation according to the first process. The first process may mean a garbage collection operation in which a reading operation of the logical address LPN from the source block, an identifying operation of valid data vd from the user data based on the logical address LPN, and a reading operation of the valid data vd from the NVM 200a and writing the read valid data vd to the destination block are sequentially performed. The memory controller 100 may control the garbage collection operation of the NVM 200a. The NVM 200a may perform the garbage collection operation under control by the memory controller 100.

The memory controller 100 may read the logical address LPN from a page included in the source block. As an example, the memory controller 100 may read the logical address LPN from the first page PG1. In some example embodiments, the memory controller 100 may sense the user data and the logical address LPN stored in a page of the source block, and transfer them from the memory cell array 210 to the data buffer 250. The NVM 200a may sense the user data and the logical address LPN stored in the first page PG1 during the sensing time as the data buffer 250 by using the memory controller 100. For example, the memory controller 100 may transfer the first user data, the second user data, the third user data, and the fourth user data and the logical address LPN corresponding to each of the pieces of user data, which are stored in the first page PG1, from the first page PG1 to the data buffer 250. The memory controller 100 may read the logical address LPN among the user data and the logical address LPN, which have been transferred to the data buffer 250. The memory controller 100 may first read only the logical address LPN.

As an example, the memory controller 100 may control a transfer operation and an output operation based on the command CMD. The transfer operation may mean an operation in which the user data and the logical address LPN stored in a page of the source block are transferred to the data buffer 250. For example, the transfer operation may be controlled by a tR command. The memory controller 100 may transfer the user data and the logical address LPN stored in a page of the source block to the data buffer 250 by using the tR command. The output operation may include an operation in which at least one of the user data and the logical address LPN transferred to the data buffer 250 is output by the data buffer 250, and may mean an operation in which the memory controller 100 reads at least one of data and the logical address LPN stored in the data buffer 250. For example, the memory controller 100 may read the logical address LPN among the user data and the logical address LPN from the data buffer 250 by using a command. The memory controller 100 may read only the valid data vd among the user data from the data buffer 250 by using a command. As an example, the output operation may be controlled by a direct memory access (DMA) command.

The memory controller 100 may determine validity of the user data stored in the page of the source block based on the logical address LPN. The memory controller 100 may determine validity of the user data stored in the first page PG1 by using the logical address LPN and mapping information. For example, the memory controller 100 may determine the second user data and the third user data as valid data vd.

In some example embodiments, the memory controller 100 may read the valid data vd from the NVM 200a. Because the valid data vd has been identified, the memory controller 100 may read only the valid data vd among the user data sensed by the data buffer 250. For example, the memory controller 100 may receive, from the data buffer 250, the second user data and the third user data, which are valid data among the first through fourth user data sensed by the data buffer 250. The memory controller 100 may, by writing the valid data vd read from the data buffer 250 to the destination block, perform the garbage collection operation according to the first process. Although it is illustrated in FIG. 6 that the logical address LPN and the valid data vd are transferred via different paths, some example embodiments is not necessarily limited thereto, and they may also be transferred via the same path according to some example embodiments.

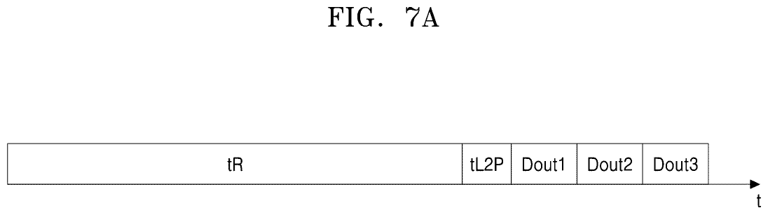

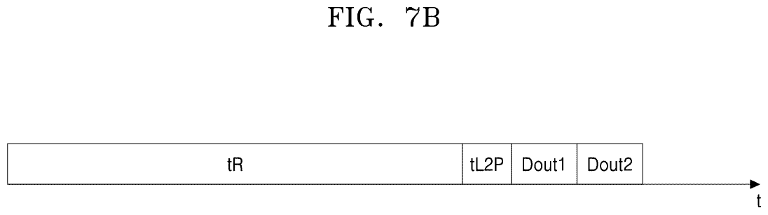

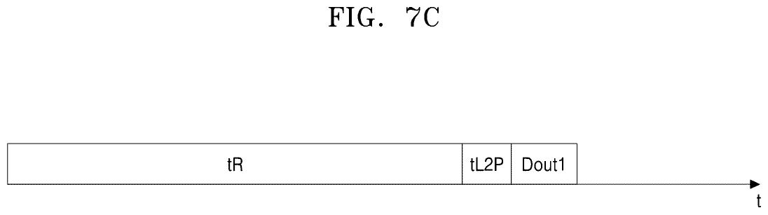

FIGS. 7A through 7C are diagrams representing at least a portion of the time of performing the garbage collection operation. FIG. 7A illustrates a case in which three pieces of user data stored in a page are valid data. In FIG. 7A, a case is assumed in which the fourth user data is non-valid data. Hereinafter, FIG. 6 is referred together. Duplicate descriptions in the descriptions given above are omitted.

Referring to FIGS. 6 and 7A, during the sensing time tR, the first user data, the second user data, the third user data, the fourth user data, and the logical address LPN corresponding to each piece of user data may be transferred from the first page PG1 to the data buffer 250. Because each piece of user data is about 4 KB, the user data and the logical address LPN, which are about 16 KB, may be sensed during the sensing time tR. For example, the sensing time tR may be about 50 μs, but is not necessarily limited thereto.

After the sensing time tR has passed, during a determination time tL2P, the logical address LPN may be transferred from the data buffer 250 to the memory controller 100, and the memory controller 100 may identify the valid data vd among the user data. The memory controller 100 may, by using the logical address LPN, determine that during the determination time tL2P, the first user data, the second user data, and the third user data are valid data. For example, the determination time tL2P may be about 2 μs, but this is only an example, and the determination time tL2P is not necessarily limited thereto. Although not illustrated in FIG. 7A, after the determination time tL2P, the memory controller 100 may transfer, to the NVM 200a, a command requesting transmission of the valid data vd.

Because three pieces of user data stored in the first page PG1 are valid data, the memory controller 100 may read the valid data stored in the first page PG1 from the data buffer 250. For example, the memory controller 100 may read the first user data from the data buffer 250 during a first read time Dout1. The memory controller 100 may read the second user data from the data buffer 250 during a second read time Dout2. The memory controller 100 may read the third user data from the data buffer 250 during a third read time Dout3. For example, each read time may be about 5 μs, but this is only an example, and each read time is not necessarily limited thereto.

FIG. 7B illustrates a case in which two pieces of user data stored in a page are valid data. In FIG. 7B, a case is assumed in which the third user data and the fourth user data arc non-valid data. Hereinafter, FIG. 6 is referred together. Duplicate descriptions in the descriptions given above are omitted.

Referring to FIGS. 6 and 7B, during the sensing time tR, the first user data, the second user data, the third user data, the fourth user data, and the logical address LPN corresponding to each piece of user data may be transferred from the first page PG1 to the data buffer 250.

The memory controller 100 may, by using the logical address LPN, determine that during the determination time tL2P, the first user data, and the second user data are valid data.

The memory controller 100 may read the valid data from the data buffer 250. For example, the memory controller 100 may read the first user data from the data buffer 250 during the first read time Dout1. The memory controller 100 may read the second user data from the data buffer 250 during the second read time Dout2.

FIG. 7C illustrates a case in which one piece of user data stored in a page is valid data. In FIG. 7C, a case is assumed in which the second user data, the third user data and the fourth user data are non-valid data. Hereinafter, FIG. 6 is referred together. Duplicate descriptions in the descriptions given above are omitted.

Referring to FIGS. 6 and 7C, during the sensing time tR, the first user data, the second user data, the third user data, the fourth user data, and the logical address LPN corresponding to each piece of user data may be transferred from the first page PG1 to the data buffer 250.

The memory controller 100 may, by using the logical address LPN, determine that during the determination time tL2P, the first user data is valid data. The memory controller 100 may read the first user data from the data buffer 250 during the first read time Dout1.

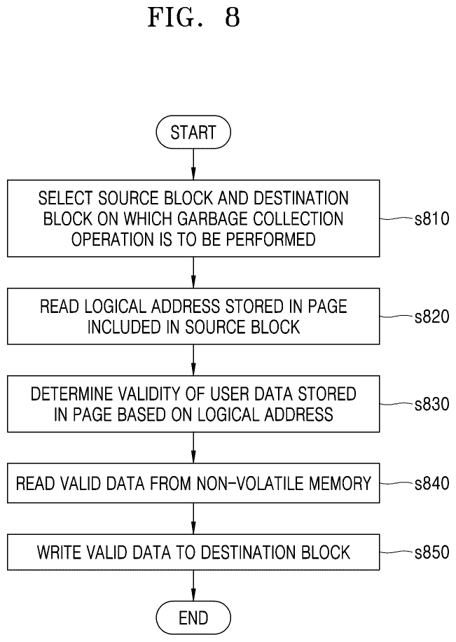

FIG. 8 is a flowchart for explaining an operating method of the memory controller 100, according to some example embodiments. FIG. 8 illustrates an operating method of the memory controller 100 in FIG. 1 and the memory controller 100 in FIG. 2. FIG. 8 illustrates a method of performing the garbage collection operation according to the first process. Duplicate descriptions in the descriptions given above are omitted.

Referring to FIG. 8, the memory controller 100 may perform a garbage collection operation of an NVM including a plurality of memory blocks. In operation s810, the memory controller 100 may select a source block and a destination block to perform the garbage collection operation from among the plurality of memory blocks. As an example, the memory controller 100 may select a source block and a destination block based on a valid page count (VPC). The memory controller 100 may also calculate the valid page count VPC, and may also receive the valid page count VPC from the NVM. A method of selecting the source block and the destination block is not necessarily limited to the example described above, and the memory controller 100 may select the source block and the destination block in various methods.

The memory controller 100 may perform the garbage collection operation on the source block and the destination block. Operations s820 through s850 may be included in the garbage collection operation. In operation s820, the memory controller 100 may read a logical address from a page included in the source block. Each page included in the source block may include the user data and the logical address. The memory controller 100 may first read the logical address among the user data and the logical address. The memory controller 100 may read the logical address which has a relatively less amount than the user data.

In operation s830, the memory controller 100 may determine validity of the user data stored in a page based on the logical address. The memory controller 100 may determine validity of the user data based on the read logical address. The user data determined to be valid among the user data stored in the page may include valid data.

In some example embodiments, the memory controller 100 may, before reading the user data from the source block, identify which user data is the valid data by using the read logical address and mapping information. As an example, the mapping information may have a form of a mapping table, and the mapping table may include information indicating a mapping relationship between the logical address and the physical address. The memory controller 100 may identify validity of the physical address corresponding to the logical address that is read by using the mapping information. The memory controller 100 may determine the user data corresponding to a valid physical address to be valid data.

In operation s840, the memory controller 100 may read the valid data from the NVM 200a. The memory controller 100 may identify the valid data, and read the valid data from the source block of the NVM 200a. In operation s850, the memory controller 100 may write the valid data to the destination block.

The memory controller 100 may first read the logical address from the page of the source block included in the NVM 200a, and after identifying the valid data included in the page based on the logical address, by reading the valid data from the source block, may perform the garbage collection operation of writing the read valid data to the destination block. Because the memory controller 100 reads only the valid data instead of all pieces of data from the source block, the data read time may be reduced and the garbage collection operation time may be reduced.

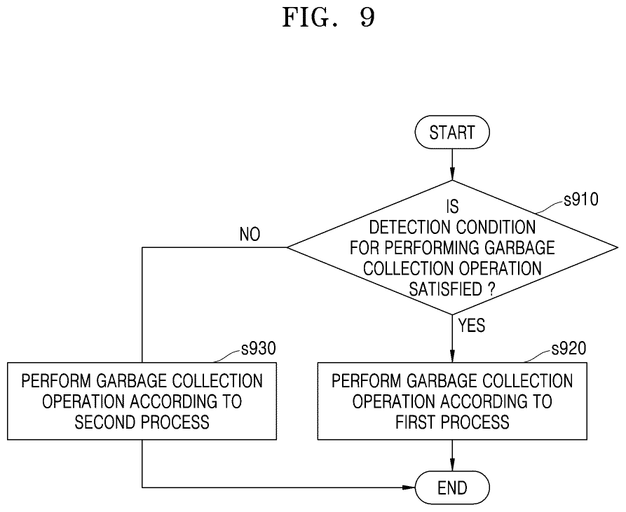

FIG. 9 is a flowchart illustrating an operating method of the memory controller 100 depending on whether a detection condition is satisfied, according to some example embodiments. Duplicate descriptions in the descriptions given above are omitted.

In some example embodiments, the memory controller 100 may control the garbage collection operating method according to whether a detection condition for performing the garbage collection operation on the source block is satisfied. In operation s910, the memory controller 100 may determine whether the detection condition for performing the garbage collection operation is satisfied. The detection condition may mean a condition for determining whether the garbage collection operation is to be performed according to the first process. The memory controller 100 may perform operation s920 when the detection condition is satisfied, and when the detection condition is not satisfied, may perform operation s930.

In some example embodiments, the detection condition may be whether a valid data count is less than a threshold. The valid data count may mean an amount of the total amount of valid data stored in the source block. The threshold may be preset, and may be set based on the performance time of the garbage collection operation. The memory controller 100 may determine that the detection condition is satisfied, when the valid data count is less than the threshold. The memory controller 100 may determine that the detection condition is not satisfied, when the valid data count is equal to or greater than the threshold.

The memory controller 100 may determine whether the detection condition is satisfied at a first time point. The first time point may mean a particular time point during the time in which the garbage collection operation is performed on the source block. In some example embodiments, the detection condition may be whether a first valid data number is equal to or greater than a second valid data number. The first valid data number may mean a valid data number that has been determined as the number of pieces of valid data of the source block until the first time point. The source block may include a plurality of pages, and the valid data of each of the plurality of pages may be sequentially determined and read by the memory controller 100. The first valid data number may include the number of pieces of valid data until the first time point, when the valid data of each of the plurality of pages is sequentially determined. The second valid data number may mean the difference between the valid data count and the first valid data number.

The memory controller 100 may determine that the detection condition is satisfied, when the first valid data number is equal to or greater than the second valid data number. The memory controller 100 may determine that the detection condition is not satisfied, when the first valid data number is less than the second valid data number. When the first valid data number is equal to or greater than the second valid data number, because the number of remaining pieces of valid data to be read is small, the garbage collection operation may be completed fast, when the garbage collection operation is performed according to the first process.

In operation s920, the memory controller 100 may perform the garbage collection operation according to the first process. The first process may mean the garbage collection operation in which the reading operation of the logical address from the source block, an identifying operation of the valid data from the user data based on the logical address, and a reading operation of the valid data from the NVM 200a and writing the read valid data to the destination block are sequentially performed.

In operation s930, the memory controller 100 may perform the garbage collection operation according to the second process. The second process may mean a garbage collection operation in which a reading operation of the logical address and the user data from the page of the source block, an identifying operation of valid data among the read user data by using the logical address, and a write operation of the identified valid data to the destination block are sequentially performed.

Because the garbage collection operation is differently performed depending on whether the detection condition is satisfied, latency of the garbage collection operation may be effectively reduced to increase the speed of the garbage collection operation, and performance of a storage device may be improved.

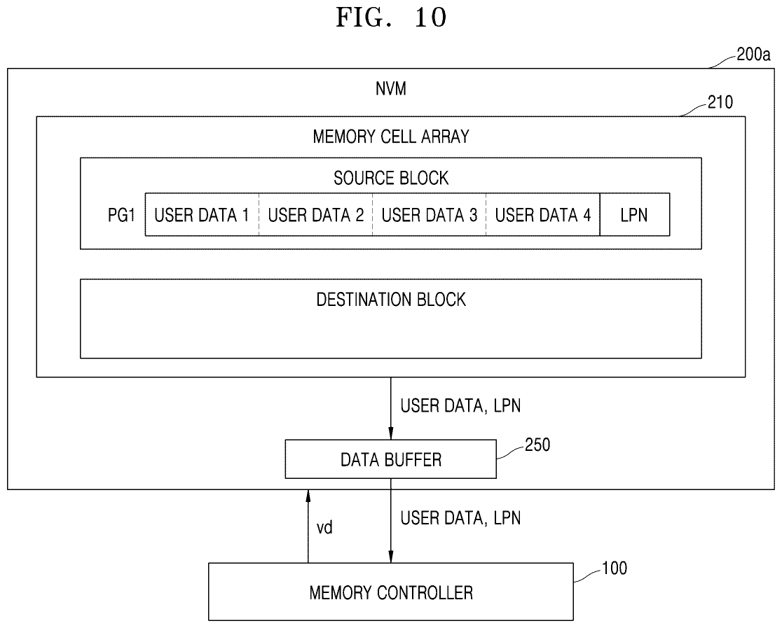

FIG. 10 is a diagram for describing the garbage collection operation according to the second process, according to some example embodiments. When the detection condition is satisfied, the memory controller 100 may perform the garbage collection operation according to the first process as described above with reference to FIG. 6, and when the detection condition is not satisfied, as described below with reference to FIG. 10, may perform the garbage collection operation according to the second process. Duplicate descriptions in the descriptions given with reference to FIG. 6 are omitted.

Referring to FIG. 10, the first page PG1 may include the user data and the logical address LPN. The memory controller 100 may perform the garbage collection operation according to the second process. The second process may mean a garbage collection operation in which a reading operation of the logical address LPN and the user data from the source block, an identifying operation of the valid data vd among the read user data based on the logical address LPN, and a write operation of the identified valid data vd to the destination block are sequentially performed.

The memory controller 100 may read the logical address LPN and the user data from a page included in the source block. As an example, the memory controller 100 may read the logical address LPN from the first page PG1. In some example embodiments, the memory controller 100 may sense the user data and the logical address LPN stored in a page of the source block, and transfer them from the memory cell array 210 to the data buffer 250.

The memory controller 100 may read the logical address LPN and the user data, which have been transferred to the data buffer 250. For example, the memory controller 100 may read the first user data, the second user data, the third user data, and the fourth user data and the logical address LPN corresponding to each of the pieces of user data, which are stored in the first page PG1, together from the data buffer 250.

The memory controller 100 may determine validity of the user data read based on the logical address LPN. The memory controller 100 may determine validity of the user data by using the logical address LPN and mapping information. For example, the memory controller 100 may determine the second user data and the third user data as valid data vd.

The memory controller 100 may, by writing the determined valid data vd to the destination block, perform the garbage collection operation according to the second process. For example, the memory controller 100 may write the second user data and the third user data to the destination block.

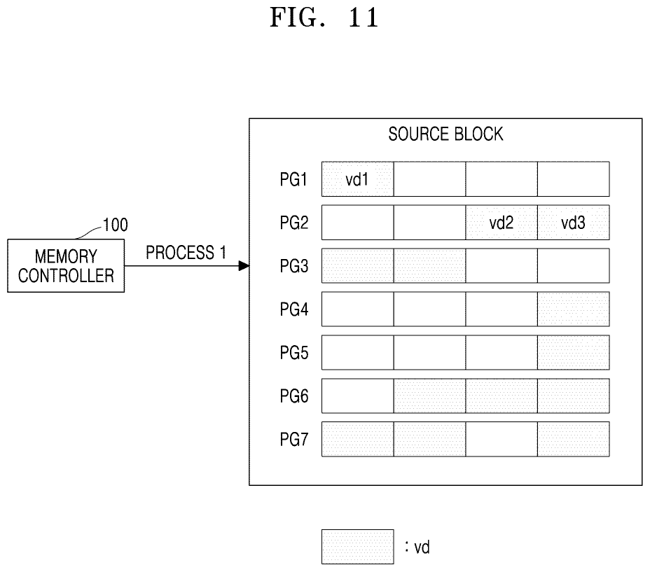

FIG. 11 is a diagram for describing a case in which the detection condition is satisfied, according to some example embodiments. FIG. 11 illustrates a case in which the valid data count is less than the threshold. It is illustrated in FIG. 11 that the source block includes first through seventh pages PG1 through PG7, but this is only for convenience of drawing, and some example embodiments is not limited thereto. Duplicate descriptions in the descriptions given above are omitted.

The memory controller 100 may perform the garbage collection operation differently according to whether the detection condition is satisfied. In some example embodiments, the detection condition may be whether the valid data count of the source block is less than a threshold. Referring to FIG. 11, the valid data count may be about 13. The threshold is assumed to be about 21.

The memory controller 100 may determine whether the valid data count is less than the threshold. As an example, because the valid data count is less than the threshold, the memory controller 100 may determine that the detection condition is satisfied. Because the detection condition is satisfied, the memory controller 100 may perform the garbage collection operation according to the first process. When the valid data count is less than the threshold, the memory controller 100 may perform the garbage collection operation according to the first process.

The memory controller 100 may perform the garbage collection on each of the first through seventh pages PG1 through PG7 according to the first process. For example, the memory controller 100 may read the logical address LPN of the first page PG1 to identify a first valid data vd1, and may read the first valid data vd1. The memory controller 100 may read the logical address LPN of the second page PG2 to identify a second valid data vd2 and a third valid data vd3, and may read the second valid data vd2 and the third valid data vd3.

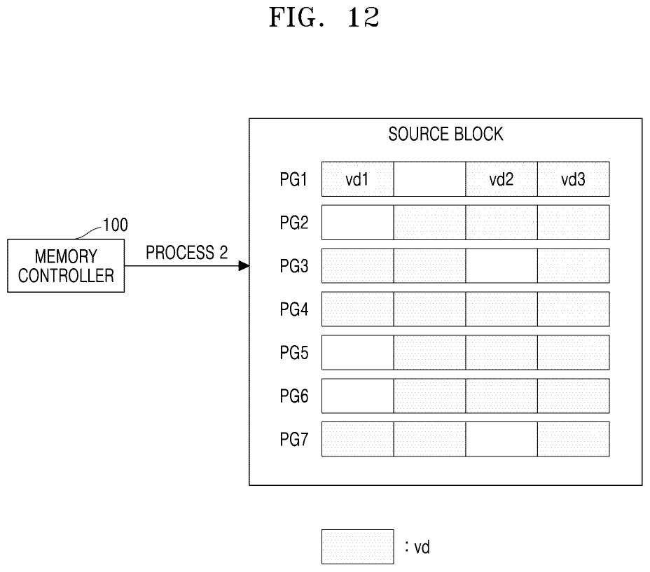

FIG. 12 is a diagram for describing a case in which the detection condition is not satisfied, according to some example embodiments. FIG. 12 illustrates a case in which the valid data count is equal to or greater than the threshold. Referring to FIG. 11, the valid data count may be about 22. The threshold is assumed to be about 21. Duplicate descriptions previously given with reference to FIG. 11 are omitted.

The memory controller 100 may determine whether the valid data count is equal to or greater than the threshold. As an example, because the valid data count is equal to or greater than the threshold, the memory controller 100 may determine that the detection condition is not satisfied. Because the detection condition is not satisfied, the memory controller 100 may perform the garbage collection operation according to the second process. When the valid data count is equal to or greater than the threshold, the memory controller 100 may perform the garbage collection operation according to the second process.

For example, the memory controller 100 may read the logical address LPN and the user data of the first page PG1 to identify the first valid data vd1, the second valid data vd2, and the third valid data vd3, and may write the first valid data vd1, the second valid data vd2, and the third valid data vd3 to the destination block.

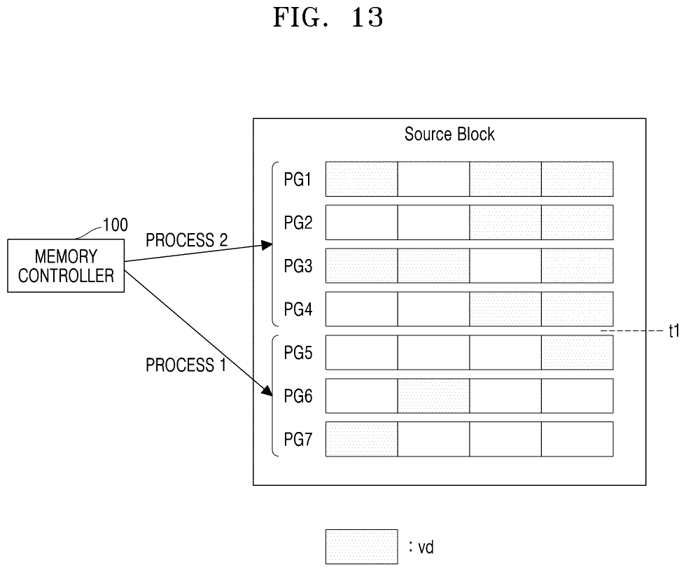

FIG. 13 is a diagram for describing a case in which the detection condition is satisfied at the first time point, according to some example embodiments. FIG. 13 illustrates a case in which the first valid data number is equal to or greater than the second valid data number at the first time point. Duplicate descriptions in the descriptions given above are omitted.

The memory controller 100 may determine where the detection condition is satisfied at a first time point t1. The first time point t1 may mean a particular time point during the time in which the garbage collection operation is performed on the source block. The memory controller 100 may determine whether the detection condition is satisfied when reading a particular page for performing the garbage collection operation among the plurality of pages included in the source block. As an example, the first time point t1 may be a time point at which reading the fifth page PG5 of the source block is to start. Among the first through seventh pages PG1 through PG7, when the garbage collection operation is performed sequentially from the first page PG1, the first through fourth pages PG1 through PG4 may correspond to pages read by the memory controller 100 before the first time point t1, and the fifth through seventh pages PG5 through PG7 may correspond to pages read by the memory controller 100 after the first time point t1.

The memory controller 100 may perform the garbage collection operation on the first through fourth pages PG1 through PG4, determine whether the detection condition is satisfied at the first time point t1, and according to whether the detection condition is satisfied, may perform the garbage collection operation on the fifth through seventh pages PG5 through PG7. In some example embodiments, the memory controller 100 may perform the garbage collection operation according to the second process until the first time point t1. For example, the memory controller 100 may perform the garbage collection operation on the first through fourth pages PG1 through PG4 according to the second process.

The memory controller 100 may perform the garbage collection operation differently according to whether the detection condition is satisfied. In some example embodiments, the detection condition may be whether the first valid data number is equal to or greater than the second valid data number. The memory controller 100 may control the garbage collection operation on the page of the source block, which is read after the first time point t1, according to a comparison result of the first valid data number and the second valid data number. The first valid data number may mean the number of pieces of valid data determined to be valid data of the source block until the first time point t1. The second valid data count may mean the difference between the valid data count and the first valid data number. FIG. 13 illustrates a case in which the valid data count is assumed to be about 13.

The memory controller 100 may determine whether the first valid data number is equal to or greater than the second valid data number at the first time point t1. The memory controller 100 may determine that the detection condition is satisfied, when the first valid data number is equal to or greater than the second valid data number. As an example, the first valid data number may be about 10, and the second valid data number may be about 3. Because the first valid data number is equal to or greater than the second valid data number, the memory controller 100 may determine that the detection condition is satisfied.

In some example embodiments, when the detection condition is satisfied, the memory controller 100 may perform the garbage collection operation on the page of the source block to be read after the first time point t1 according to the first process. As an example, because the detection condition is satisfied, the memory controller 100 may perform the garbage collection operation on the first through fourth pages PG1 through PG4 according to the second process, and may perform the garbage collection operation on the fifth through seventh pages PG5 through PG7 to be read after the first time point t1 according to the first process.

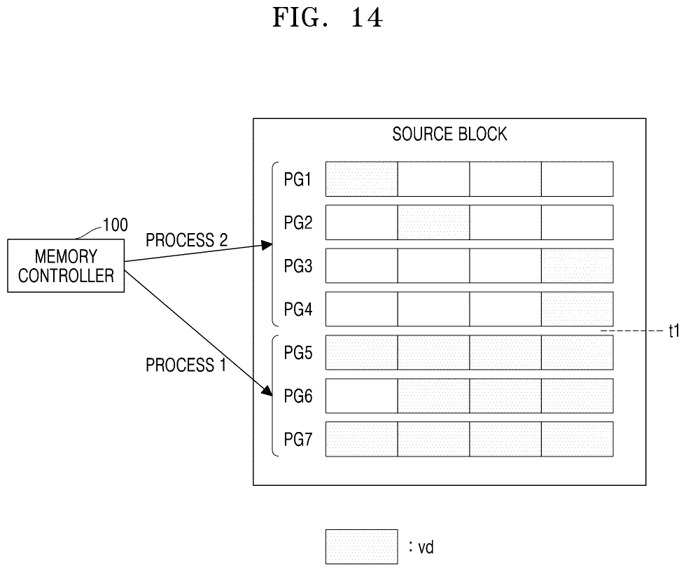

FIG. 14 is a diagram for describing a case in which the detection condition is not satisfied at the first time point t1, according to some example embodiments. FIG. 13 illustrates a case in which the first valid data number is less than the second valid data number at the first time point t1. Duplicate descriptions given with reference to FIG. 13 are omitted.

The memory controller 100 may perform the garbage collection operation differently according to whether the detection condition is satisfied. In some example embodiments, the detection condition may be whether the first valid data number is equal to or greater than the second valid data number. FIG. 14 illustrates a case in which the valid data count is assumed to be about 15.

The memory controller 100 may determine that the detection condition is not satisfied, when the first valid data number is less than the second valid data number. As an example, the first valid data number may be about 4, and the second valid data number may be about 11. Because the first valid data number is less than the second valid data number, the memory controller 100 may determine that the detection condition is not satisfied.

In some example embodiments, when the detection condition is not satisfied, the memory controller 100 may control the garbage collection operation on the page of the source block to be read after the first time point t1 to be the same as the garbage collection operation on the page of the source block read until the first time point t1. When the detection condition is not satisfied, the garbage collection operation may be performed on pages of the source block according to the same process.

When the detection condition is not satisfied, the memory controller 100 may perform the garbage collection operation on the page of the source block to be read after the first time point t1 according to the second process. As an example, because the detection condition is not satisfied, the memory controller 100 may perform the garbage collection operation on the first through fourth pages PG1 through PG4 according to the second process, and may perform the garbage collection operation on the fifth through seventh pages PG5 through PG7 to be read after the first time point t1 according to the second process. In other words, the memory controller 100 may perform the garbage collection operation on the first through seventh pages PG1 through PG7 according to the second process.

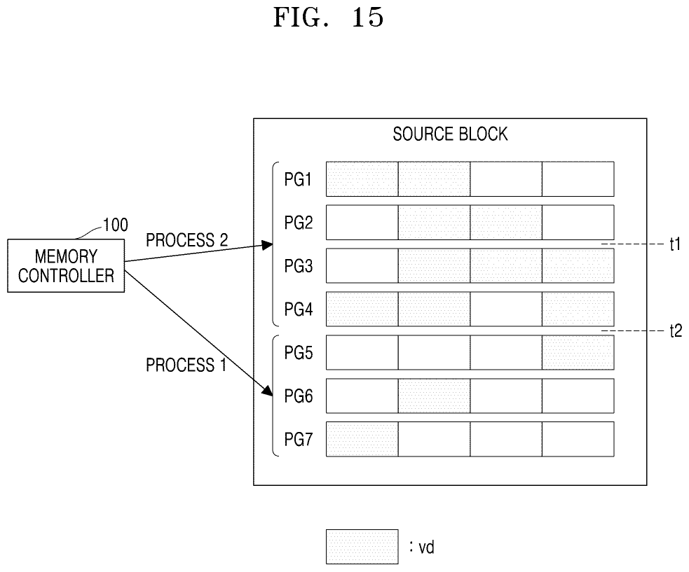

FIG. 15 is a diagram for describing a case of determining whether the detection condition is satisfied at a plurality of time points, according to some example embodiments. FIG. 15 illustrates a case in which the first valid data number is equal to or greater than the second valid data number at the second time point t2. Duplicate descriptions in the descriptions given above are omitted.

The memory controller 100 may determine where the detection condition is satisfied at a plurality of time points. The memory controller 100 may determine where the detection condition is satisfied at the first time point t1 and the second time point t2. Each of the first time point t1 and the second time point t2 may mean a particular time point during the time in which the garbage collection operation is performed on the source block. As an example, the first time point t1 may be a time point at which reading the second page PG2 of the source block is to start. The second time point t2 may be a time point at which reading the fifth page PG5 of the source block is to start. Among the first through seventh pages PG1 through PG7, when the garbage collection operation is performed sequentially from the first page PG1, the first and second pages PG1 and PG2 may correspond to pages read by the memory controller 100 before the first time point t1, and the third through seventh pages PG3 through PG7 may correspond to pages read by the memory controller 100 after the first time point t1. The first through fourth pages PG1 through PG4 may correspond to pages read by the memory controller 100 before the second time point t2, and the fifth through seventh pages PG5 through PG7 may correspond to pages read by the memory controller 100 after the second time point t2.

In some example embodiments, the memory controller 100 may perform the garbage collection operation according to the second process until the first time point t1. For example, the memory controller 100 may perform the garbage collection operation on the first and second pages PG1 and PG2 according to the second process. The memory controller 100 may perform the garbage collection operation differently according to whether the detection condition is satisfied. FIG. 15 illustrates a case in which the valid data count is assumed to be about 13.

The memory controller 100 may determine whether the first valid data number is equal to or greater than the second valid data number at the first time point t1. As an example, at the first time point t1, the first valid data number may be about 4, and the second valid data number may be about 9. Because the first valid data number is less than the second valid data number, the memory controller 100 may determine that the detection condition is not satisfied. Because the detection condition is not satisfied at the first time point t1, the memory controller 100 may perform the garbage collection operation on the page of the source block to be read after the first time point t1 according to the second process. As an example, the memory controller 100 may perform the garbage collection operation on the first through fourth pages PG1 through PG4 according to the second process.

The memory controller 100 may determine whether the first valid data number is equal to or greater than the second valid data number at the second time point t2. As an example, at the second time point t2, the first valid data number may be about 10, and the second valid data number may be about 3. Because the first valid data number is equal to or greater than the second valid data number, the memory controller 100 may determine that the detection condition is satisfied. Because the detection condition is satisfied at the second time point t2, the memory controller 100 may perform the garbage collection operation on the page of the source block to be read after the second time point t2 according to the first process. As an example, the memory controller 100 may perform the garbage collection operation on the first through fourth pages PG1 through PG4 according to the second process, and may perform the garbage collection operation on the fifth through seventh pages PG5 through PG7 according to the first process. In some embodiments, when the first valid data number is equal to or greater than the second valid data number at the first time point t1, the memory controller 100 may not determine whether the detection condition is satisfied at the second time point t2.

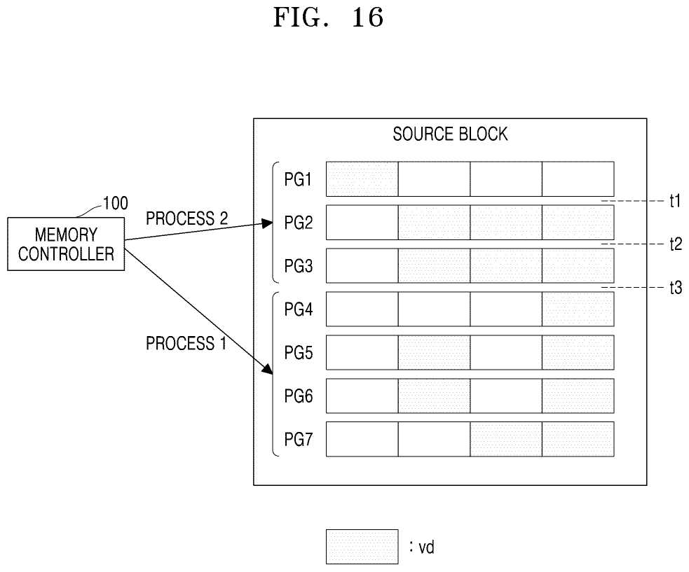

FIG. 16 is a diagram for describing a case of determining whether the detection condition is satisfied at each time when a page is read, according to some example embodiments. FIG. 16 illustrates a case in which the first valid data number is equal to or greater than the second valid data number at a third time point t3. Duplicate descriptions in the descriptions given above are omitted.

The memory controller 100 may determine where the detection condition is satisfied at a plurality of time points. In some example embodiments, each time each of the plurality of pages of the source block is read, the memory controller 100 may determine whether the detection condition is satisfied. As an example, the first time point t1 may be a time point at which reading the second page PG2 of the source block is to start. The second time point t2 may be a time point at which reading the third page PG3 of the source block is to start. The third time point t3 may be a time point at which reading the fourth page PG4 of the source block is to start.

In some example embodiments, the memory controller 100 may determine whether the detection condition is satisfied each time when each of the plurality of pages of the source block is read, and may perform the garbage collection operation according to the second process. The memory controller 100 may perform the garbage collection operation differently according to whether the detection condition is satisfied. FIG. 16 illustrates a case in which the valid data count is assumed to be about 13. In some example embodiments, after the detection condition is satisfied, the memory controller 100 may not determine whether the detection condition is satisfied each time when each of the plurality of pages of the source block is read.

The memory controller 100 may determine whether the first valid data number is equal to or greater than the second valid data number at the first time point t1. As an example, at the first time point t1, the first valid data number may be about 1, and the second valid data number may be about 12. Because the first valid data number is less than the second valid data number, the memory controller 100 may determine that the detection condition is not satisfied.

The memory controller 100 may determine whether the first valid data number is equal to or greater than the second valid data number at the second time point t2. As an example, at the second time point t2, the first valid data number may be about 4, and the second valid data number may be about 9. Because the first valid data number is less than the second valid data number, the memory controller 100 may determine that the detection condition is not satisfied.

The memory controller 100 may determine whether the first valid data number is equal to or greater than the second valid data number at the third time point t3. As an example, at the second time point t2, the first valid data number may be about 7, and the second valid data number may be about 6. Because the first valid data number is equal to or greater than the second valid data number, the memory controller 100 may determine that the detection condition is satisfied. Because the detection condition is satisfied at the third time point t3, the memory controller 100 may perform the garbage collection operation on the page of the source block to be read after the third time point t3 according to the first process. As an example, the memory controller 100 may perform the garbage collection operation on the first through third pages PG1 through PG3 according to the second process, and may perform the garbage collection operation on the fourth through seventh pages PG4 through PG7 according to the first process.

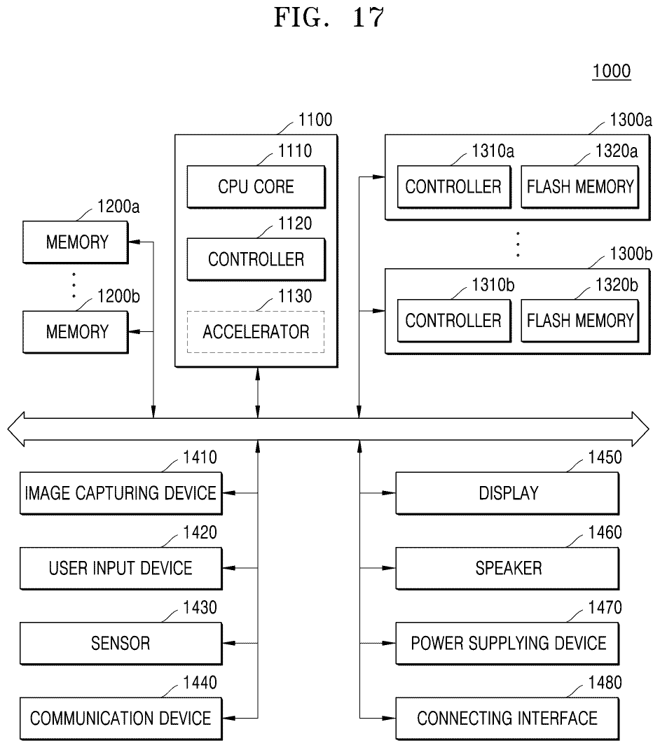

FIG. 17 is a system to which storage devices are applied according to some example embodiments. The system 1000 of FIG. 17 may basically include a mobile system such as a mobile phone, a smartphone, a tablet personal computer (PC), a wearable device, a health care device, or an Internet of Things (IoT) device. However, the system 1000 of FIG. 17 is not necessarily limited to the mobile system, and may also include a PC, a laptop computer, a server, a media player, or an automotive device such as a navigation device.

Referring to FIG. 17, the system 1000 may include a main processor 1100, memories 1200a and 1200b, and storage devices 1300a and 1300b, and in addition, may include one or more of an image capturing device 1410, a user input device 1420, a sensor 1430, a communication device 1440, a display 1450, a speaker 1460, a power supplying device 1470, and a connecting interface 1480.

The main processor 1100 may control an overall operation of the system 1000, and more particularly, may control operations of other components constituting the system 1000. The main processor 1100 may be implemented as a general purpose processor, a dedicated processor, an application processor, etc.

The main processor 1100 may include one or more CPU cores 1110, and may further include a controller 1120 for controlling the memories 1200a and 1200b and/or the storage devices 1300a and 1300b. According to some example embodiments, the main processor 1100 may further include an accelerator 1130, which is a dedicated circuit for a high speed data computation such as an artificial intelligence (AI) data computation. The accelerator 1130 may include a graphics processing unit (GPU), a neural processing unit (NPU), and/or a data processing unit (DPU), or the like, and may be implemented as a separate chip, which is physically independent of other components of the main processor 1100.

The memories 1200a and 1200b may be used as a main memory device of the system 1000, and may include a volatile memory such as SRAM and/or DRAM, but may also include an NVM such as flash memory, PRAM, and/or RRAM. The memories 1200a and 1200b may be implemented in the same package as the main processor 1100.

The storage devices 1300a and 1300b may store data as a non-volatile storage device regardless of a power supply, and may have a relatively larger storage capacity than the memories 1200a and 1200b. The storage devices 1300a and 1300b may include storage controllers 1310a and 1310b, and NVMs 1320a and 1320b storing data under control by the storage controllers 1310a and 1310b, respectively. The NVMs 1320a and 1320b may include a V-NAND flash memory having a 2D or a 3D vertical NAND structure, but may also include NVMs of different types, such as PRAM and/or RRAM. A storage device described with reference to FIGS. 1 through 16 (for example, the storage device 10 of FIG. 1) may be applied to the storage devices 1300a and 1300b in FIG. 17.

The storage devices 1300a and 1300b may alternatively or additionally be included in the system 1000 in a state of physical separation from the main processor 1100, and may also be implemented in the same package as the main processor 1100. In addition, the storage devices 1300a and 1300b may have the same shape as a shape of an SSD or a memory card, and thus, may be also detachably combined with other components of the system 1000 via an interface such as the connecting interface 1480 to be described below. The storage devices 1300a and 1300b may include one or more devices to which standard convention, such as one or more of a universal flash storage (UFS), an embedded multimedia card (eMMC), and NVM express (NVMe) is applied, but are not necessarily limited thereto.

The image capturing device 1410 may capture static image or video image, and may include a camera, a camcorder, and/or a webcam, etc. The user input device 1420 may receive various types of data input by a user of the system 1000, and may include a touch pad, a keypad, a keyboard, a mouse, and/or a microphone. The sensor 1430 may sense various types of physical amount obtainable from the outside of the system 1000, and may convert the sensed physical amount into one or more electrical signals, e.g., one or more digital and/or analog signals. The sensor 1430 may include one or more of a temperature sensor, a pressure sensor, an illuminance sensor, a location sensor, an acceleration sensor, a biosensor, and/or a gyroscope, etc.

The communication device 1440 may perform transceiving of a signal between other devices outside the system 1000 according to various communication conventions. The communication device 1440 may be implemented by including an antenna, a transceiver, and/or a MODEM, etc. The display 1450 and the speaker 1460 may respectively function as output devices for outputting visual information and audio information to a user of the system 1000. The power supplying device 1470 may properly convert power supplied by a battery (not illustrated) embedded in the system 1000 and/or an external power source, and provide the converted power to each component of the system 1000.

The connecting interface 1480 may provide a connection between the system 1000 and an external device, which is connected to the system 1000 and exchanges data with the system 1000. The connecting interface 1480 may include and/or be implemented by using various interface methods, such as one or more of ATA, SATA, external SATA (e-SATA), SCSI, serial attached SCSI (SAS), PCI, PCIe, NVMe, IEEE 1394, universal serial bus (USB), a secure digital (SD) card, a multi-media card (MMC), an embedded MMC (eMMC), UFS, embedded UFS (eUFS), and a CF card interface.

While various inventive concepts have been particularly shown and described with reference to embodiments thereof, it will be understood that various changes in form and details may be made therein without departing from the spirit and scope of the following claims.

1. A storage device comprising:
a non-volatile memory device including a plurality of memory blocks; and
a memory controller configured to control a garbage collection operation of copying valid data of a source block among the plurality of memory blocks to a destination block,
wherein the memory controller is configured to,
read a logical address stored in a page included in the source block,
determine a validity of user data stored in the page included in the source block based on the logical address,
read the valid data, which includes the user data determined to be valid, from the non-volatile memory device, and
perform a write operation on the destination block by transferring the read valid data to the non-volatile memory device.

2. The storage device of claim 1, wherein the memory controller is configured to map information between a physical address and the logical address, the physical address indicating a location at which the user data is stored in the non-volatile memory device,
identify validity of the physical address corresponding to the logical address based on the mapping information, and
determine the user data corresponding to a valid physical address to be the valid data.

3. The storage device of claim 1, wherein
the non-volatile memory device further comprises a data buffer configured to output the user data sensed by the plurality of memory blocks,
wherein the memory controller is configured to
transfer the user data stored in the page and the logical address corresponding to the user data from the page of the source block to the data buffer, and
read the logical address among the user data and the logical address transferred to the data buffer.

4. The storage device of claim 1, wherein the memory controller is configured to
determine whether a valid data count indicating an amount of entire valid data stored in the source block is equal to or greater than a threshold, and
control the garbage collection operation different according to whether the valid data count is equal to or greater than the threshold.

5. The storage device of claim 4, wherein
in response to the valid data count of the source block being less than the threshold with respect to each of a plurality of pages comprised in the source block, the memory controller is configured to,
read the logical address, and
after identifying the valid data by using the logical address, reading the valid data from the non-volatile memory device and writing the read valid data to the destination block perform the garbage collection operation.

6. The storage device of claim 4,
in response to the valid data count stored in the source block being equal to or greater than the threshold, with respect to each of a plurality of pages comprised in the source block,
after reading the logical address and the user data, the memory controller is configured to identify the valid data among the read user data, and by writing the identified valid data among the read user data to the destination block performs the garbage collection operation.

7. The storage device of claim 1,
wherein the memory controller is configured to compare a first valid data number determined to be the valid data of the source block until a first time point with a valid data count indicating an amount of entire valid data stored in the source block, and
according to a comparison result, to control the garbage collection operation on the page of the source block to be read after the first time point.

8. The storage device of claim 7, wherein with respect to the page of the source block to be read until the first time point,
after reading the logical address and the user data, the memory controller is configured to identify the valid data among the read user data, and by writing the identified valid data among the read user data to the destination block, performs the garbage collection operation.

9. The storage device of claim 7, wherein
in response to the first valid data number being equal to or greater than a second valid data number corresponding to a difference between the valid data count and the first valid data number, and with respect to the page of the source block to be read after the first time point,
the memory controller is configured to read the logical address, after identifying the valid data by using the logical address, read the valid data from the non-volatile memory device and writing the read valid data to the destination block, and perform the garbage collection operation.

10. The storage device of claim 7, wherein
in response to the first valid data number being less than a second valid data number corresponding to a difference between the valid data count and the first valid data number,
the memory controller is configured to control the garbage collection operation on the page of the source block to be read after the first time point to be identical to the garbage collection operation on the page of the source block read until the first time point.

11. (canceled)

12. A storage device comprising:
a non-volatile memory device including a plurality of memory blocks; and
a memory controller configured to control a garbage collection operation of copying valid data of a source block among the plurality of memory blocks to a destination block,
wherein the memory controller is configured to determine whether a detection condition for performing a garbage collection operation on the source block is satisfied,
in response to the detection condition being satisfied, perform the garbage collection operation according to a first process, in which a logical address stored in a page included in the source block is read, and
in response to the detection condition not being satisfied, perform the garbage collection operation according to a second process, in which the logical address and user data stored in the page included in the source block are read.

13. The storage device of claim 12, wherein by reading the logical address, identifying the valid data from the user data based on the logical address, reading the valid data from the non-volatile memory device, and writing the read valid data to the destination block, the memory controller is configured to perform the garbage collection operation according to the first process.

14. The storage device of claim 12, wherein by reading the logical address and the user data, identifying the valid data from the user data based on the logical address, and writing the identified valid data to the destination block, the memory controller is configured to perform the garbage collection operation according to the second process.

15. The storage device of claim 12, wherein
the detection condition is based on whether a valid data count indicating an amount of entire valid data stored in the source block is less than a threshold, and
in response to the valid data count being less than the threshold, the memory controller is configured to determine that the detection condition is satisfied.

16. The storage device of claim 15,
in response to the valid data count being less than the threshold, the memory controller is configured to perform the garbage collection operation on each of a plurality of pages comprised in the source block according to the first process, and
in response to the valid data count being equal to or greater than the threshold, the memory controller is configured to perform the garbage collection operation on each of a plurality of pages comprised in the source block according to the second process.

17. The storage device of claim 12, wherein
the detection condition is based on whether, at a first time point, a first valid data number determined to be the valid data of the source block until the first time point is equal to or greater than a second valid data number, and
the second valid data number corresponds to a difference between the valid data count and the first valid data number.

18. The storage device of claim 17, wherein the memory controller is configured to perform the garbage collection operation on the page of the source block to be read until the first time point according to the second process.

19. The storage device of claim 17, wherein
in response to the first valid data number being equal to or greater than the second valid data number, the memory controller is configured to determine that the detection condition is satisfied, and
the memory controller is configured to perform the garbage collection operation on the page of the source block to be read after the first time point according to the first process.

20. The storage device of claim 17,
in response to the first valid data number being less than the second valid data number, the memory controller is configured to determine that the detection condition is not satisfied, and
to perform the garbage collection operation on the page of the source block to be read after the first time point according to the second process.

21. An operating method of a memory controller configured to perform a garbage collection operation, the operating method comprising:
selecting a source block and a destination block among a plurality of memory blocks included in a non-volatile memory device; and
performing the garbage collection operation on the source block and the destination block,
wherein the performing of the garbage collection operation comprises,
reading a logical address stored in a page included in the source block,
determining validity of user data stored in the page based on the logical address,
reading, from the non-volatile memory device, valid data determined to be valid among the user data, and
writing the valid data to the destination block.

22-23. (canceled)
